(19) United States
(12) Patent Application Publication
(10) Pub. No.: US 2016/0096329 A1
(43) Pub. Date: Apr. 7, 2016

(54) 3D TOOLING MACHINE

(71) Applicant: Flux Technology LLC, Sunnyvale, CA (US)

(72) Inventors: Xuan-En Ko, Kaohsiung (TW); Chun-Jen Yu, Pingtung (TW); Shang-Fon Chiang, Taipei (TW)

(21) Appl. No.: 14/504,162

(22) Filed: Oct. 1, 2014

(51) Int. Cl. B29C 67/00

(52) U.S. Cl. CPC B29C 67/0088; B33Y 30/00

(57) ABSTRACT

Some embodiment includes a 3D tooling machine. The 3D tooling machine can include: a base station; slider blocks; rods that are adapted to support the top cap, run through the slider blocks and plug into the base station; slider arms with rounded ends that are adapted to magnetically attach to the slider blocks and magnetically attach to a tool head; and a controller configured to control movement of the slider blocks along the rods via one or more motors or actuators.

### RELATED FIELD

At least one embodiment of this disclosure relates generally to a consumer 3D printer system.

### BACKGROUND

3D printing utilizes various processes for making a three-dimensional object from a 3D model primarily through additive processes in which successive layers of material are laid down under computer control. Traditionally, a 3D printer is an industrial robot used mostly by industries. There are some consumer 3D printers on the market. However, it is difficult to deliver these 3D printers directly to the consumers. Further, it is often a challenge for a consumer to operate one of these 3D printers in a home environment. Consumer 3D printers often times also lacks the capability to refine a final product and thus forcing the 3D creation process to be a one-time process.

### BRIEF DESCRIPTION OF THE DRAWINGS

FIG. 1 is a top view of a 3D printer, in accordance with various embodiments.

FIG. 2 is a perspective side view of the 3D printer of FIG. 1, in accordance with various embodiments.

FIG. 3A is a first perspective view of a print head for use with a 3D printer, in accordance with various embodiments.

FIG. 3B is a second perspective view of the print head of FIG. 3B, in accordance with various embodiments.

FIG. 4 is a side view of the 3D printer of FIG. 1 without a top cap, in accordance with various embodiments.

FIG. 5 is a side view of the 3D printer of FIG. 1 before a print head is mechanically coupled to slider arms, in accordance with various embodiments.

FIG. 6 is a side view of the 3D printer of FIG. 5 after the print head is mechanically coupled to slider arms, in accordance with various embodiments.

FIG. 7 is a detailed side view of the print head of FIG. 5 during an assembly stage, in accordance with various embodiments.

FIG. 8 is a side view of the print head of FIG. 5 during operation, in accordance with various embodiments.

FIG. 9 is a side view of the base station of the 3D printer of FIG. 1, in accordance with various embodiments.

FIG. 10 is a perspective view of the base station with a rotatable platform exposed, in accordance with various embodiments.

FIG. 11 is a perspective view of the base station with a light projector exposed, in accordance with various embodiments.

FIG. 12 is a perspective view of the base station while scanning an object with the light projector, in accordance with various embodiments.

FIG. 13 is an exploded diagram of components of a 3D printer, in accordance with various embodiments.

FIG. 14 is a components diagram of the components of a 3D printer of laid out on a surface, in accordance with various embodiments.

FIG. 15 is a block diagram of a consumer 3D printer system, in accordance with various embodiments.

FIG. 16 is a side view of the print head of FIG. 5 over the base station of the 3D printer of FIG. 1.

The figures depict various embodiments of this disclosure for purposes of illustration only. One skilled in the art will readily recognize from the following discussion that alternative embodiments of the structures and methods illustrated herein may be employed without departing from the principles of the invention described herein.

### DETAILED DESCRIPTION

Disclosed is a 3D printer designed for convenient consumer use. While this device is described as a “3D printer,” because of the additional features that are available, the 3D printer can also be referred to as a 3D tooling machine.

### Modularity for Convenient Assembly

For example, in some embodiments, the 3D printer includes modular components that can attach to one another. This advantageously enables the manufacturer of the 3D printer to ship its components that are packaged independently (e.g., independently laid out without pre-attachment in the same package or in different packages) in a space efficient manner.

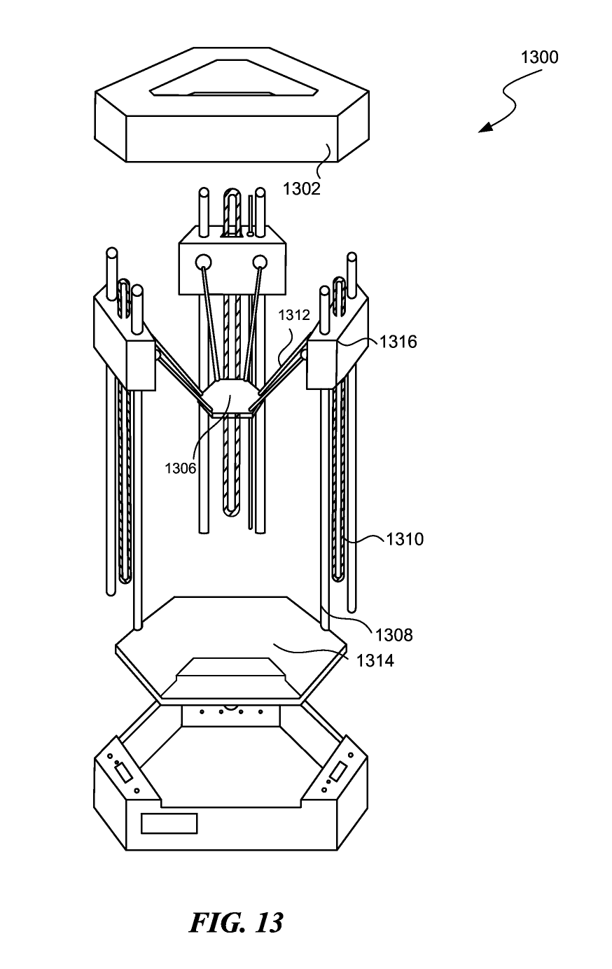

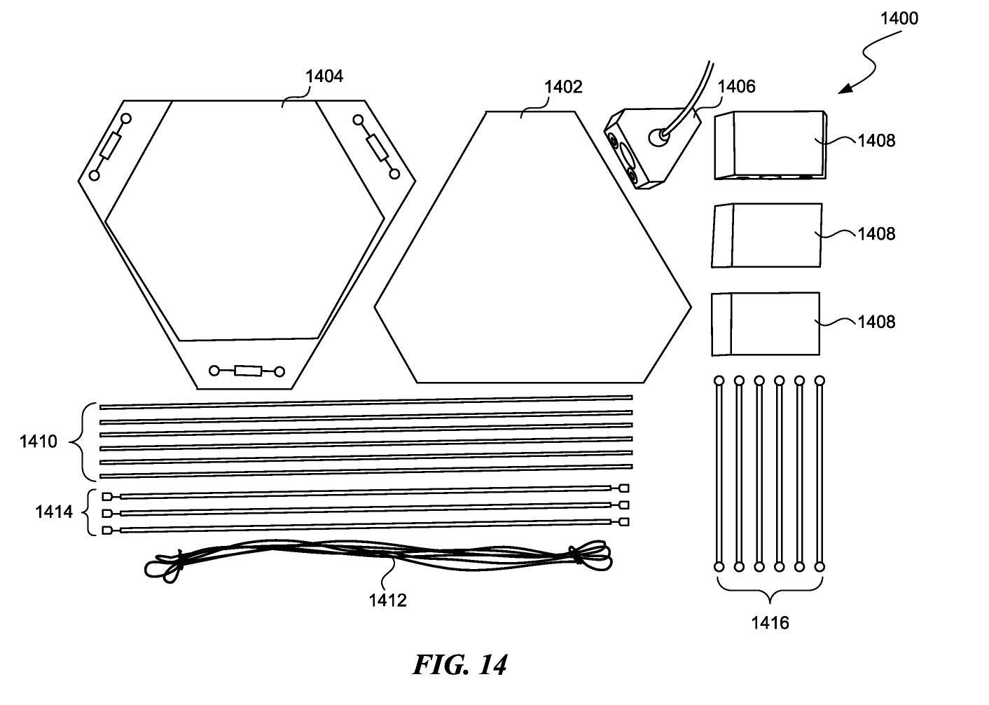

For example, FIG. 14 is a components diagram of the components of a 3D printer 1400 laid out on a surface, in accordance with various embodiments. These components can be packaged independently. FIG. 13 is an exploded diagram of components of a 3D printer 1300 that illustrate an example of how the components can be assembled together.

For example, the components can include a top cap, a base station, one or more print heads or tool heads, one or more tool head control sliders, one or more rods (e.g., for the control sliders to slide along), one or more conveyor belts to move the control sliders, one or more slider arms to couple to a tool head, one or more data and/or power interconnects, a removable platform, or any combination thereof. In the illustrated embodiment in FIG. 13, a 3D printer 1300 can include: a top cap 1302, a base station 1304, a tool head 1306, three pairs of rods 1308 and three conveyor belts 1310, six slider arms 1312, a removable platform 1314, and three control slider blocks 1316. Each component may include other subcomponents. For example, the base station 1304 can include a power supply or a power source, a controller (e.g., Rasberry Pi, Arduino, or an application specific integrated circuit (ASIC)), one or more motors or actuators for driving the conveyor belts or other moving parts of the 3D printer, or any combination thereof. In the illustrated embodiment in FIG. 14, a 3D printer 1400 can include: a top cap 1402, a base station 1404, a print head 1406, three control sliders 1408, six rods 1410, three conveyor belts 1412, three interconnects 1414, and six slider arms 1416.

The disclosed assembly architecture of a 3D printer enables convenient replacement of parts and convenient assembly by a potential user of the 3D printer. For example, the slider arms can be attached to the control sliders via magnetic attachment joints (e.g., a ferromagnetic bearing that accepts a ferromagnetic round joint of the slider arm).

### Detachable Interface to Install Different Tool Heads

In some embodiments, the 3D printer has a detachable interface to install various tool heads. Traditional 3D printers have static print heads. The detachable interface enables a consumer user to efficiently modify the 3D printer to create and/or modify 3D objects using different tools, under different circumstances, and/or for various applications. In some embodiments, the detachable interface is enabled by a quick attachment/release mechanism to couple or decouple a tool head. The detachable tool head can be a print head that melts a thermoplastic filament and deposits the thermoplastic filament through a nozzle onto a platform of the 3D printer. The detachable interface is compatible with print heads having different nozzle sizes that can be adapted for different 3D printing resolutions and print speeds. For example, a bigger nozzle size may correspond to faster printing with lesser resolution and a smaller nozzle size may correspond to slower printing with higher resolution.

In some embodiments, the detachable tool head is a laser tool head. The laser tool head can be used to carve shapes and designs into an object placed on the platform of the 3D printer. For yet another example, a consumer user can install a detachable milling tip that is compatible with the detachable interface. The 3D printer can drive the milling tip (i.e., rotate the milling tip) such that the milling tip can carve into an object placed on the platform.

In some embodiments, the detachable tool head is a pen holder. A consumer user can fasten a writing tool (e.g., a pencil, a brush, a pen, a chalk, a color spray, or any combination thereof) in the pen holder. After calibration, the 3D printer can drive the pen holder to draw on a three-dimensional surface of an object placed on the platform.

### Removable Platform

In some embodiments, the 3D printer has a removable platform (e.g., a glass plate) to support an object for printing or modification (e.g., laser carving, milling, drawing, etc.). The removable platform can rest on a base station of the 3D printer. In some embodiments, the removable platform can rest on at least three pressure sensors. The three pressure sensors can be used to calibrate the flatness of the removable platform. The three pressure sensors can also be used to determine whether or not the tool head is pressing against either the removable platform or an object resting on the removable platform.

In some embodiments, the removable platform can have multiple ferromagnetic chips coupled to corresponding ferromagnetic chips in or attached on the base station. That is, there can be one or more pairs of ferromagnetic chips attached or embedded respectively to the removable platform and the base station. In some embodiments, at least one of the ferromagnetic chips in each pair is a permanent magnet. In some embodiments, at least one of the magnet in each pair is a ferromagnetic material that can be temporarily magnetized (e.g., a piece of iron). The magnetic coupling between the removable platform and the base station can ensure that the removable platform is flatly laid out on the base station. Further, the magnetic coupling also enables sensors (e.g., pressure sensors) in or on the base station to mechanically coupled to the removable platform closely to detect weight distribution on the removable platform. This weight distribution information can be used for calibration, tool head alignment, or a combination thereof.

### Object Scanning Capability

In some embodiments, the 3D printer can have object scanning capability. For example, these 3D printer can have a rotatable platform. In some embodiments, the rotatable platform can be embedded in the base station and the removable platform can be laid thereon. In some embodiments, the rotatable platform can substitute the removable platform. A motor or actuator (e.g., controlled by a controller in the 3D printer or a controller in wired or wireless communication with a logic unit in the 3D printer) can rotate the rotatable platform. In turn, the rotatable platform rotates an object such that a camera can capture a three-dimensional surface of the object.

The 3D surface can be scanned by projecting a laser line from a light projector (e.g., a laser light projector). In some embodiments, the light projector can be a retractable device that is capable of remaining hidden underneath a top surface the base station, and popping up above the top surface using a click release mechanism. In some embodiments, there can be multiple light projectors around the rotatable platform in the base station.

The base station can also include a camera arm attached to an optical scanner (e.g., a digital camera). The camera arm and the optical scanner can be hidden underneath a top surface of the base station. In some embodiments, a click release mechanism can be coupled to the camera arm such that the camera arm can be rotated out (e.g., around a pivot joint underneath a top surface of the base station.

In operation, at least one of the light projectors can project a laser line (e.g., a vertical line substantially perpendicular to a top surface of the base station) towards an object placed on the rotatable platform. A controller of the 3D printer can command a motor to rotate the rotatable platform while the optical scanner measures the optical characteristic of the laser line projected by the light projector and reflected from a 3D surface of an object. In those embodiments, the 3D printer can include a wired or wireless interface. For example, utilizing measurements of the degree of attenuation reflected from the object, the controller can generate a 3D model of the object after the rotatable platform rotates for at least 360°. In some embodiments, the controller can rotate the rotatable platform for less than 360° to capture and generate a partial 3D surface of the object.

The generated 3D model can be saved in a memory device of the 3D printer, such as a hard disk, a flash drive, a removable memory, or any combination thereof. In some embodiments, the generated 3D model can be pushed to an external computing device, such as a smart phone, a desktop computer, a cloud storage, a wearable device, or any combination thereof. In those embodiments, the 3D printer can include a wired or wireless interface. For example, the controller can push the 3D model via Bluetooth, Wi-Fi, USB interconnect, or any combination thereof.

In some embodiments, at a later time after the 3D model is generated, a user can place the removable platform back over the base station and the rotatable platform. The user can then use the 3D model to drive any one of the print heads to print the 3D model (e.g., using consumable filament) on the removable platform. The user can also use one of the other tool heads to carve the 3D model onto an existing object placed on the removable platform.

### Tool Head Control

In various embodiments, a controller in the 3D printer can command movements of the tool head by driving one or more actuators and/or motors in the 3D printer. A 3D creation operation (e.g., printing, carving, engraving or writing) may be initiated remotely on an external device (e.g., via a wired or wireless connection). The external device can be a cloud server, a personal computing device (e.g., a mobile phone, a tablet, a laptop, or a personal desktop), or an electronic switch. When executing the 3D creation operation, the controller can access an electronic file that indicates a plurality of three-dimensional consecutive coordinates. The electronic file, for example, can be a text file (e.g., GCode) or a binary file. The controller can receive the electronic file wirelessly (e.g., via Wi-Fi, Bluetooth, or near field communication (NFC)). Preferably when transferring the electronic file, the electronic file is transferred as a binary to reduce bandwidth requirement of the transfer. That way, the controller can also interpret the consecutive coordinates without interpreting text first. The controller can access the electronic file through a wired interconnect (e.g., in universal serial bus (USB)). The controller can access the electronic file in an internal memory, portable memory, or external memory. In some embodiments, the external device can command the movements of the tool head in real-time without first providing the electronic file.

The external device can include a model database. The model database can store one or more electronic files storing sets of the consecutive coordinates to operate a 3D printer. The external device can also implement a model editing tool. In some embodiments, the external device can take a G-code file (e.g., a text file describing a 3D model using 3D coordinates as text) as input and output a binary file. The external device can generate metadata (e.g., 3D model size, 3D model complexity, number of coordinates, total path lengths between the coordinates, or any combination thereof) associated with a G-Code file or the corresponding binary file by analyzing the coordinates described in the file. The external device can generate a thumbnail based on the G-code file or the corresponding binary file. The thumbnail can be used to preview the 3D model. The metadata and the thumbnail can be stored in the G-code file or the binary file.

Conventionally, a “.gcode” file for a 3D printer only contains coordinate information and other robotic arm movement instructions in text. However, the 3D model described by the “.gcode” file cannot be readily illustrated. The generation of the thumbnail enables a user of the 3D printer to visualize the file. For example, the thumbnail can be visualized via a mobile application running on a mobile device wirelessly coupled to the 3D printer. For another example, the thumbnail can be visualized via a web page accessible to a mobile device.

The “.gcode” file consists of human readable instructions. However, such human readable instructions are not optimal for electronics transfer. Accordingly, the external device (e.g., a mobile device) can convert the “.gcode” file into a binary/machine-readable file prior to transferring to the 3D printer. The machine-readable format can, for example, save up to 40% in data storage size and can also save in processing performance.

### Calibration and Alignment

The 3D printer can calibrate and align its robotic motor control of a tool head. In some embodiments, the vertical depth of the tool head can be calibrated by moving the control slider blocks all the way down such that the tool head moves all the way down. When the tool head contacts a platform (e.g., a removable platform or a rotatable platform) or a workpiece (e.g., target object), one or more force sensors (e.g., for sensitive resistors) coupled to (e.g., attached beneath, within or on) the platform can detect the force of the contact. This enables the controller of the 3D printer to determine the bottom depth limit for operating the tool head. The controller can also raise the control slider blocks all the way up until the control slider blocks trigger switches or pressure/force sensors at the top of the rods or at the top cap. This enables the controller of the 3D printer to determine the upper limit for operating the tool head.

The depth calibration mechanism described above can be advantageous especially in using a laser tool head. The focus distance of the laser from a working surface ensures accurate carving. The laser tool head can keep going down until the force sensors detect that the tool head has made contact. After that, the tool head can rise to the right position automatically for a good focus.

The 3D printer can also align the tool head along a plane parallel to the top surface of the platform. To achieve this, the tool head can project a directional light onto the platform. In the case of the laser tool head, low power laser can be projected down to the platform. The direction light can provide a guidance for the operating user to align the workpiece to the tool head. A logic module implemented by the controller can generate an outline of an alignment pattern for the operating user and show the outline by a moving weak laser point. This alignment process leverages the operating user such that the 3D printer would not require complicated machinery to perform the alignment.

### Printer Head Cooling System

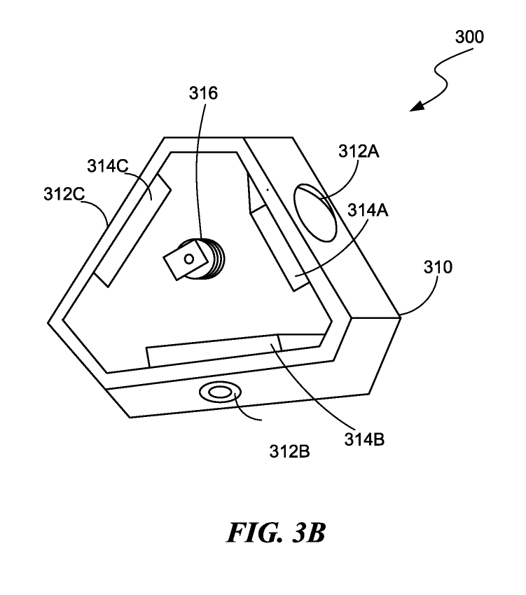

In some embodiments, a tool head (e.g., a print head) includes a cooling system. For example, a print head includes a heating element to melt solid filament into liquid to deposit onto the removable platform of the disclosed 3D printer. To ensure that the solid filament solidifies quickly, a fan can blow directly as the nozzle of the print head or slightly below the nozzle. The print head can also include a set of pass-through openings. For example, an intake fan can suck air into the print head through a first opening while an exhaust fan can blow air out of the print head through a second opening. Further examples of such cooling system is further described in FIG. 3A and FIG. 3B. This cooling system can apply to other tool heads as well.

### Optional Tool Head Components

In some preferred embodiments, a print head has a power cable and a filament transport tube. However, in some embodiments, a tool head (e.g., a print head or other carving or writing tool) includes a signal cable as well. The signal cable can carry electronic signal the outputs from the tool head or electronic control signal to control an active component of the tool head.

For example, in some embodiments, a tool head can include one or more sensors. For example, a tool head can have an inertial sensor or a force sensor (e.g., for sensitive resistor) to detect whether or not the tool head becomes decoupled from at least one of the slider arms. The inertial or force sensor can also be used to detect whether or not the tool head has fallen down. The measurements of the one or more sensors can be carried through the signal cable back to the controller of the 3D printer.

For another example, in some embodiments, a tool head can include a camera to assist with aligning a tool head to a target object that is the subject of an operation involving the tool head. For example, the camera can detect a two dimensional coordinate of where the target object is an move the tool head to be directly over the target object. The images or video stream of the camera can be carried through the signal cable back to the controller of the 3D printer.

In some embodiments, a tool head can include a valve control. In those embodiments, the controller of the 3D printer can command the valve control to open or constrict a valve at the nozzle of a print head or a writing/painting tool. The commands to the valve control can be carried through the signal cable.

In some embodiments, a print head can include a heating element control. In those embodiments, the controller of the 3D printer can command the heating element control to decrease or raise the temperature of a heating element. For example, the heating element can be used to liquefy a solid filament provided through the filament transport tube.

In most preferred embodiments, the tool head does that include sensor elements that provide dynamic feedback. Instead, the tool head can rely on the disclosed calibration and alignment methodologies to actually produce the intended object based on a 3D model without the complexity of a real-time feedback system. In most preferred embodiments, a tool head lacks an actuator. While the tool head without an actuator is unable to tilt, the tool head without any moving parts is more stable and saves power.

### Mechanisms for Operational Convenience

In some embodiments, the 3D printer can include a filament quick release mechanism. For example, the filament quick release mechanism can be located at a top cap of the 3D printer. The filament quick release mechanism can be a spring mechanism that pushes out the filament that is inserted into the 3D printer through a feeding hole. In some embodiments, the filament quick release mechanism works only when the other end of the filament in the print head is melting.

In some embodiments, the 3D printer can include a tube quick release mechanism. The tube quick release mechanism enables a consumer user to release the filament transport tube conveniently from a feeder nozzle (e.g., double-sided valve) in the 3D printer. For example, the tube quick release mechanism can operate by pulling back a rigid sealing ring to release the filament tube. For another example, the tube quick release mechanism can operate by a spring mechanism or a slot mechanism to pop out the filament tube from the feeder nozzle. One side of the feeder nozzle can connect with the feeding hole for the filament. The other side of the feeder nozzle can connect with the filament transport tube. The feeder nozzle can be connected to a filament extruding motor that pushes the filament toward the print head during operation.

### External Connections

In some embodiments, the disclosed 3D printer can include one or more external connection interfaces. For example, the 3D printer can include a power interface for taking in a DC or AC power input. For another example, the 3D printer can include a control interface to take in a control signal (e.g., a USB signal). For yet another example, the 3D printer can include a memory reader interface to access (e.g., read or write) a removable memory device.

### Modular Top Cap and Base Station

In some embodiments, the top cap includes a filament extruding motor controlled by the controller. In some embodiments, the top cap includes multiple extruding motors to support printing two types of material at once. In some embodiments, the top cap includes a plastic furnace to accept recyclable plastic as filament.

In some embodiments, the base station includes a modular tool slot adapted to fit at least a rotatable platform, a heating plate, a machine-readable memory device, a logic computing module (e.g., one-board computer such as Res-Pi or ARM board), or any combination thereof. For example, the heating plate is adapted to heat a removable glass plate that is adapted to fit over the base station.

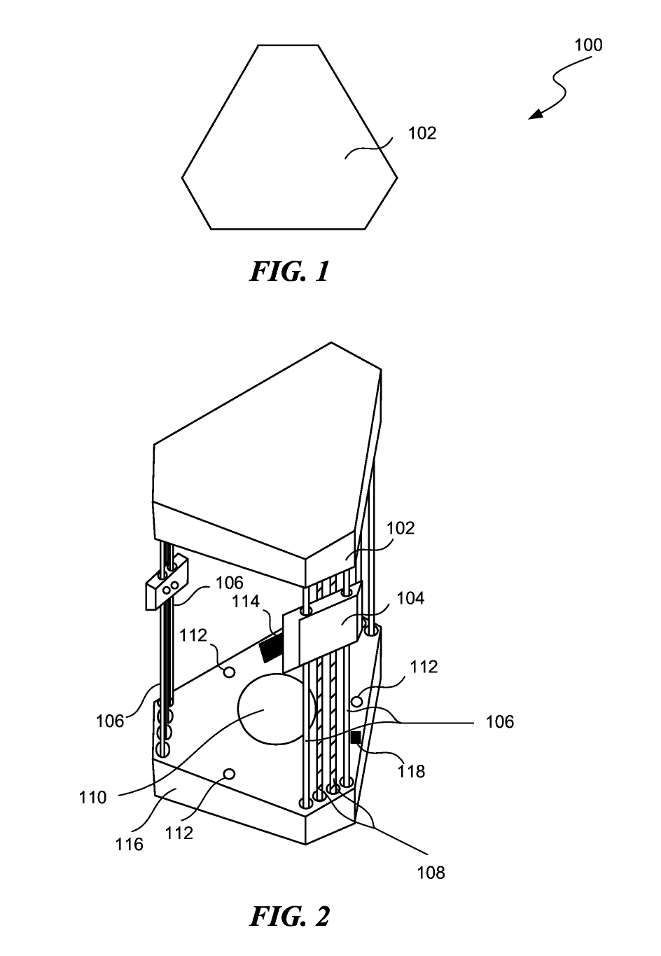

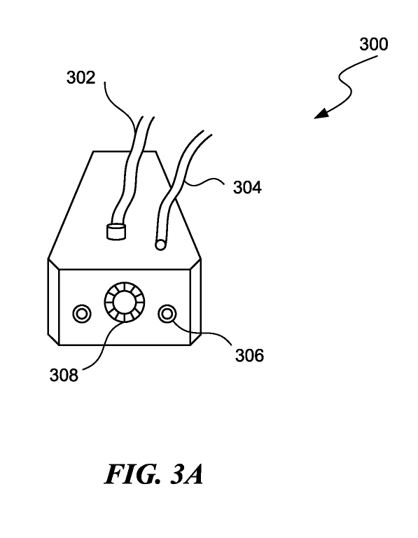

FIG. 1 is a top view of a 3D printer 100, in accordance with various embodiments. The 3D printer 100 includes a top cap 102. FIG. 2 is a perspective side view of the 3D printer 100 of FIG. 1, in accordance with various embodiments. The top cap 102 can be coupled to a base station 116 via multiple rods 106. In some embodiments, the top cap 102 and the base station 116 have approximately a triangular shape as illustrated. The rods 106 may include three pairs, one pair attached to each corner of the top cap 102 and the base station 116. The top cap 102 can be attached to other components of the 3D printer 100 without a fastening mechanism (e.g., by fitting to one or more of the rods 106.

The 3D printer 100 can also include slider blocks 104. For example, there may be one slider block for each pair of the rods 106. The slider blocks 104 may each include one or more holes through which one or more of the rods 106 penetrate. This coupling enables the slider blocks 104 to slide up and down along the rods 106.

The 3D printer 100 can include one or more conveyor belts 108 to control the individual movements of the slider blocks 104 along the rods 106. For example, a controller chip (not shown) in the top cap 102 or the base station 116 can control one or more actuators or motors to move the conveyor belts 108. In turn, movement of the slider blocks, when coupled to a tool head (not shown), can move the tool head within a three-dimensional space above the base station 116.

In some embodiments, the base station 116 can include force sensors 112. Measurements from the force sensors 112 can be used by the controller to detect weight distribution on a platform on the base station 116. For example, the platform can be a removable platform (not shown). For another example, the platform can be a rotatable platform 110 that is capable of rotating in response to the controller's command. The force sensors 112 can be placed underneath the rotatable platform 110 or the removal platform.

In some embodiments, the base station 116 can include one or more light projectors 118, such as a laser pointer. The light projectors 118 can be secured underneath a top surface of the base station 116 via a click release mechanism. In response to someone clicking on a light projector, the click release mechanism can pop up the light projector. In some embodiments, the base station 116 can include a scanner assembly 114 (e.g., a camera arm and an optical sensor). The scanner assembly 114 can also be secured underneath the top surface of the base station 116 via a click release mechanism.

FIG. 3A is a first perspective view of a print head 300 for use with a 3D printer, in accordance with various embodiments. The print head 300 can include an interface to couple with a filament tube 302. The print head 300 can include an interface to couple with a power cable 304. The print head 300 can include a magnetic attachment interface 306 to couple with a slider arm (not shown). For example, the print head 300 can include a pair of the magnetic attachment interfaces on three vertical surfaces. The print head 300 can include a fan 308. The fan can be an intake fan or an exhaust fan.

FIG. 3B is a second perspective view of the print head 300 of FIG. 3A, in accordance with various embodiments. The print head 300 can have a frame 310 that makes up a loop. The loop can be centered around an axis perpendicular to a top surface of the 3D printer's base station. The frame 310 can expose an opening 312A coupled to a fan 314A, an opening 312B coupled to a fan 314B, and an opening 312C coupled to a fan 314C. For example, the fan 314A and the fan 314B can be used to cool down a nozzle 316 that includes a heating element to melt the consumable filament. The air can flow from the opening 312A to the opening 312B. The fan 314C can directly blow on the hot filament that is just getting out of the nozzle 316. In some embodiments, the air sucked through the opening 312C can be exhausted through a void (e.g., a bottom void opening or a top void opening) formed by the frame 310. This additional cooling solidifies the printing material quicker and increase the accuracy of the printed product.

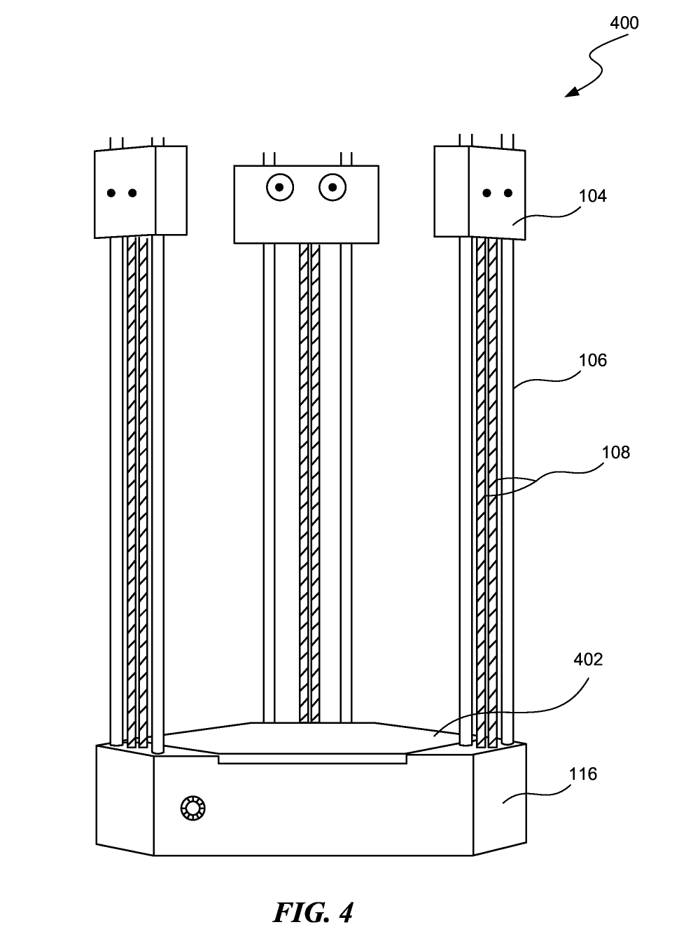

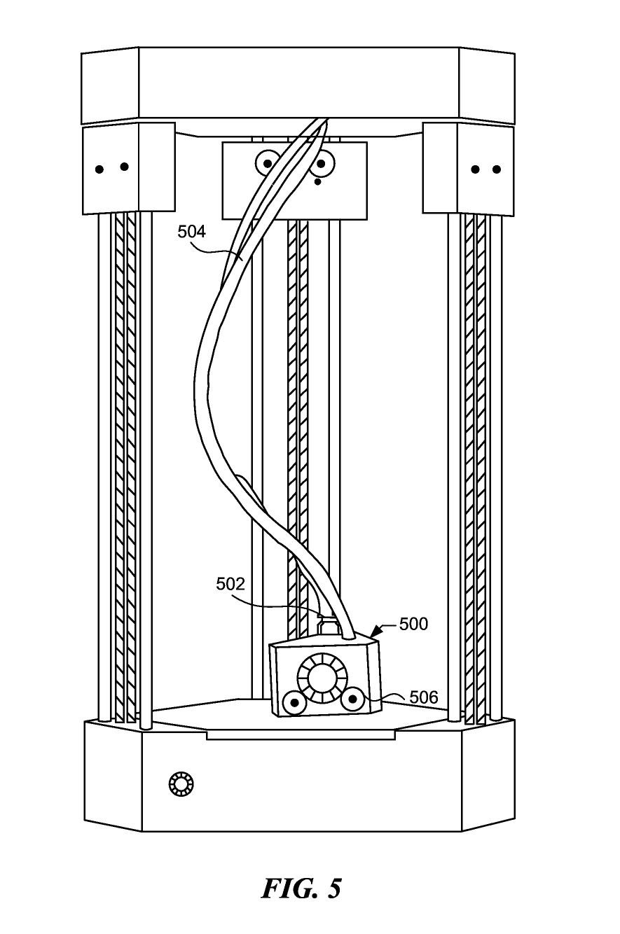

FIG. 4 is a side view of the 3D printer 100 of FIG. 1 without a top cap, in accordance with various embodiments. The 3D printer 100 can include a removable platform 402, such as a glass plate. FIG. 5 is a side view of the 3D printer 100 of FIG. 1 before a print head 500 (e.g., the print head 300 of FIG. 3A) is mechanically coupled to slider arms, in accordance with various embodiments. The print head 500 can include a filament transport tube 502 connected to a nozzle (e.g., the nozzle 316 of FIG. 3B). The filament transport to 502 can be the filament tube 302 of FIG. 3A. The print head 500 can be coupled to a power cable 504, such as the power cable 304 of FIG. 3A. The print head 500 can include magnetic attachment interfaces 506.

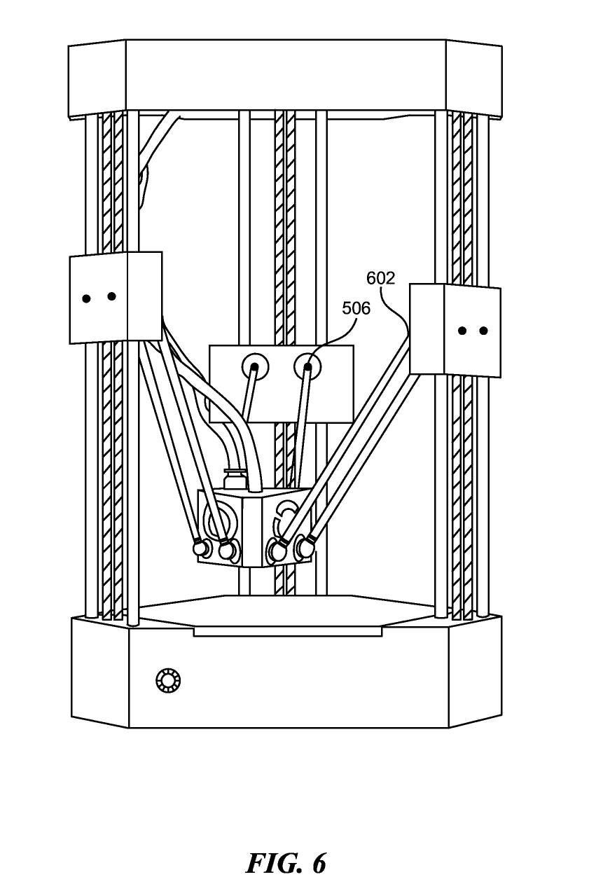

FIG. 6 is a side view of the 3D printer of FIG. 5 after the print head 500 is mechanically coupled to slider arms 602, in accordance with various embodiments. The slider arms 602 can be magnetically attached to the magnetic attachment interfaces 506 of the print head 500. For example, a slider arm can be a rod with rounded ferromagnetic ends. For example, the slider arms 602 can be iron bars. In some embodiments, the rounded ends are magnetized. In some embodiments, the magnetic attachment interfaces 506 of the print head 500 are magnetized. The magnetic attachment mechanism enables a user of the 3D printer 100 to quickly attach different tool heads to the slider blocks 104 controlled by the controller of the 3D printer 100. That is, the print head 500 can be conveniently replaced with any number of tool heads available.

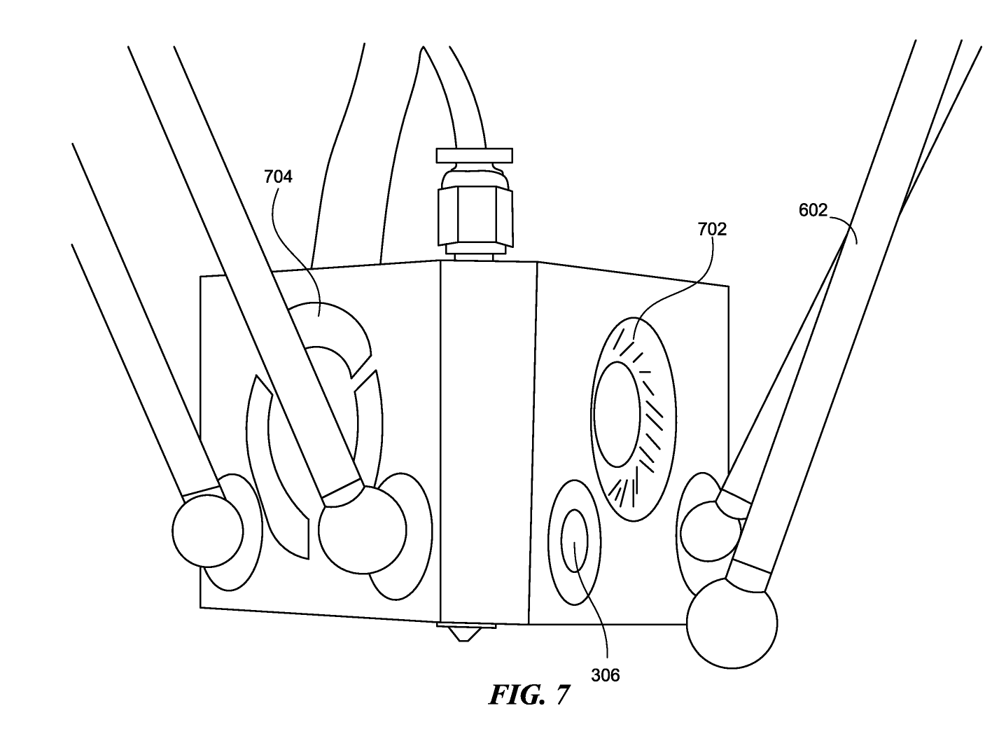

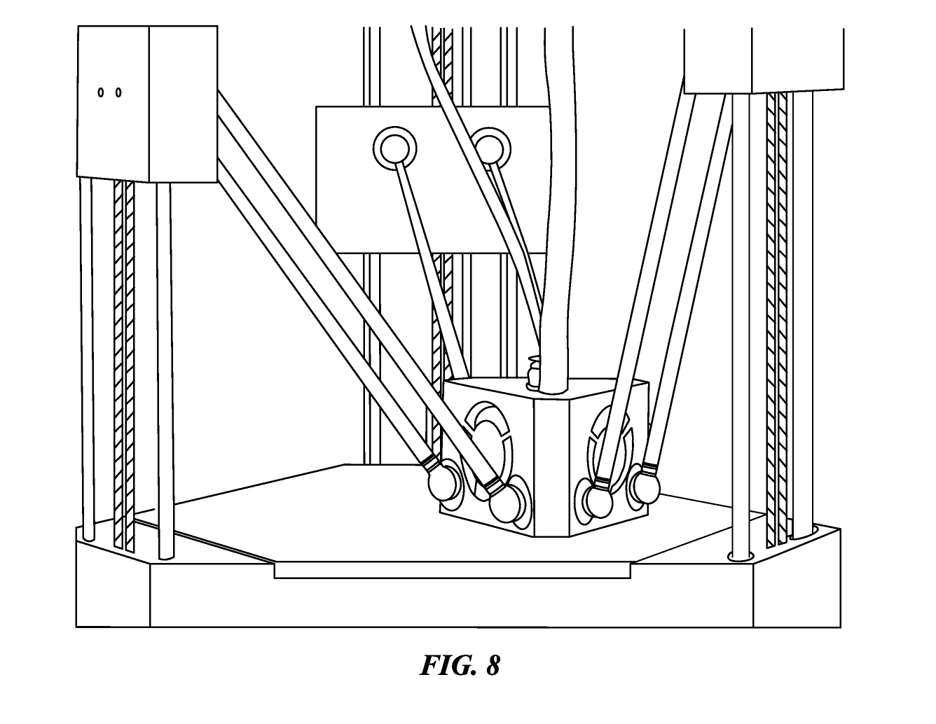

FIG. 7 is a detailed side view of the print head 500 of FIG. 5 during an assembly stage, in accordance with various embodiments. The detailed side view shows that some of the slider arms 602 having magnetically attached to the print head 500. The detailed side view also shows a slider arm 602 having detached from the print head 500. The print head 500 can include an intake fan 702 and an exhaust fan 704. FIG. 8 is a side view of the print head 500 of FIG. 5 during operation, in accordance with various embodiments.

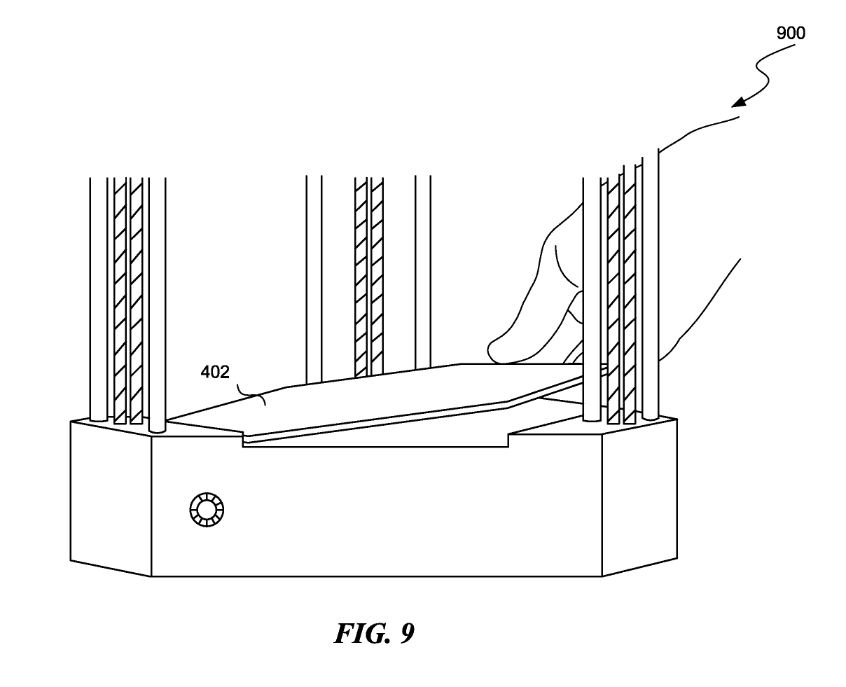

FIG. 9 is a side view of the base station 116 of the 3D printer of FIG. 1, in accordance with various embodiments. The top cap 402 can be placed on top of the base station 116 without mechanical attachment. Rather, the top cap 402 can include at least three ferromagnetic chips (not shown) on one of its sides for magnetic attachment to the base station 116. In some embodiments, the side with the ferromagnetic chips is configured to face toward the base station 116. In other embodiments, the sigh with the ferromagnetic chips is configured to face away from the base station 116.

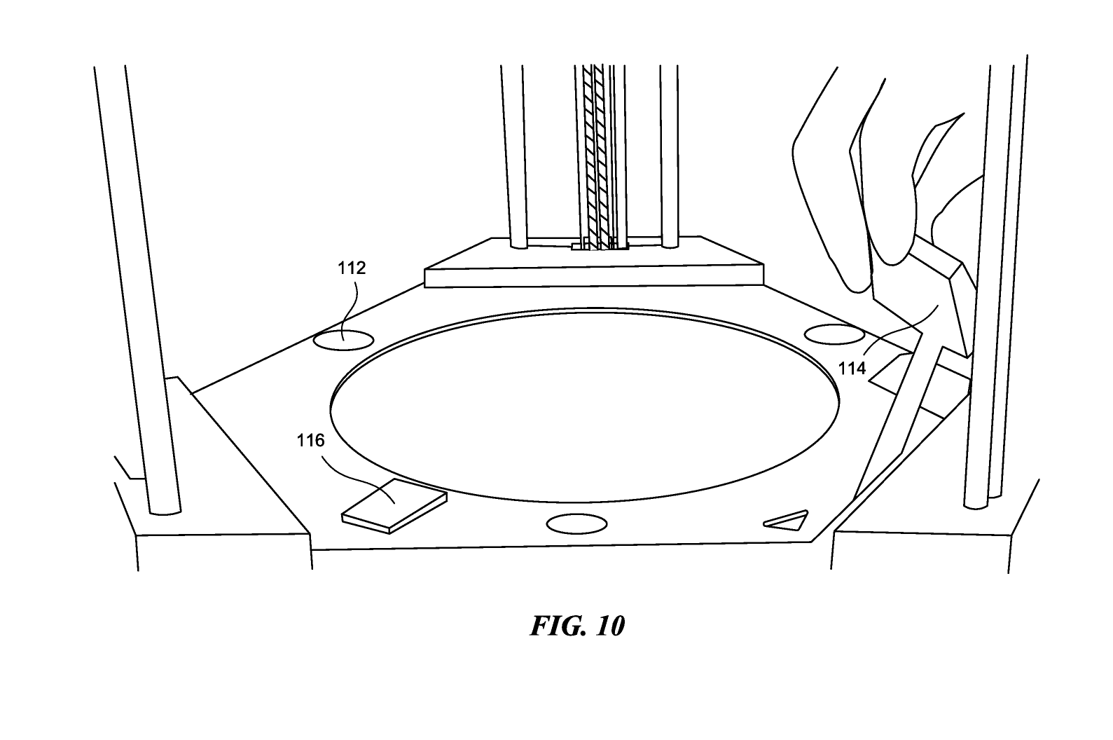

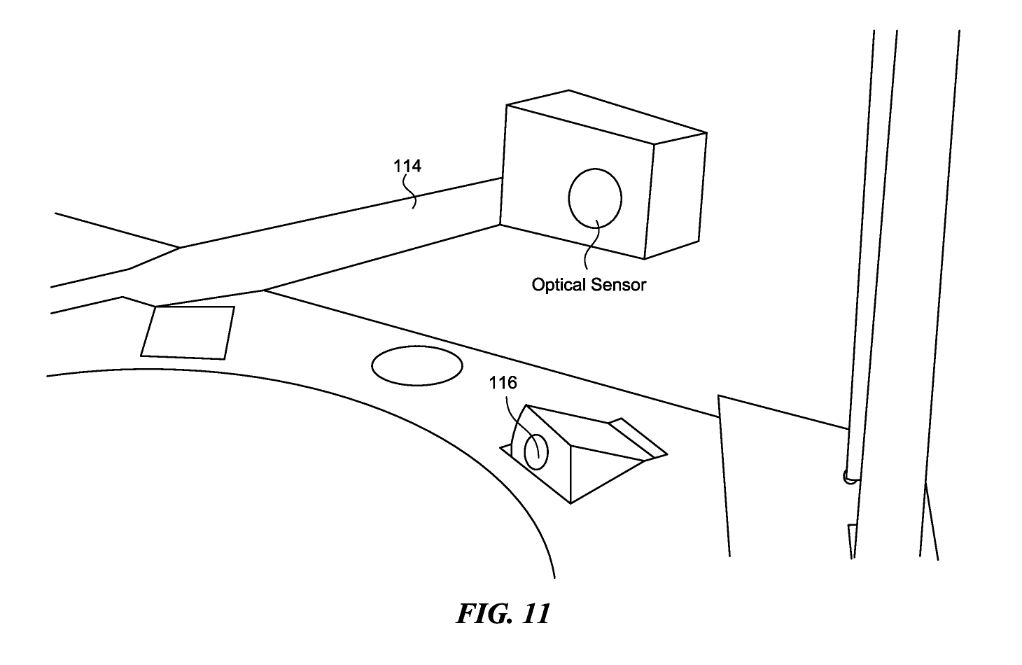

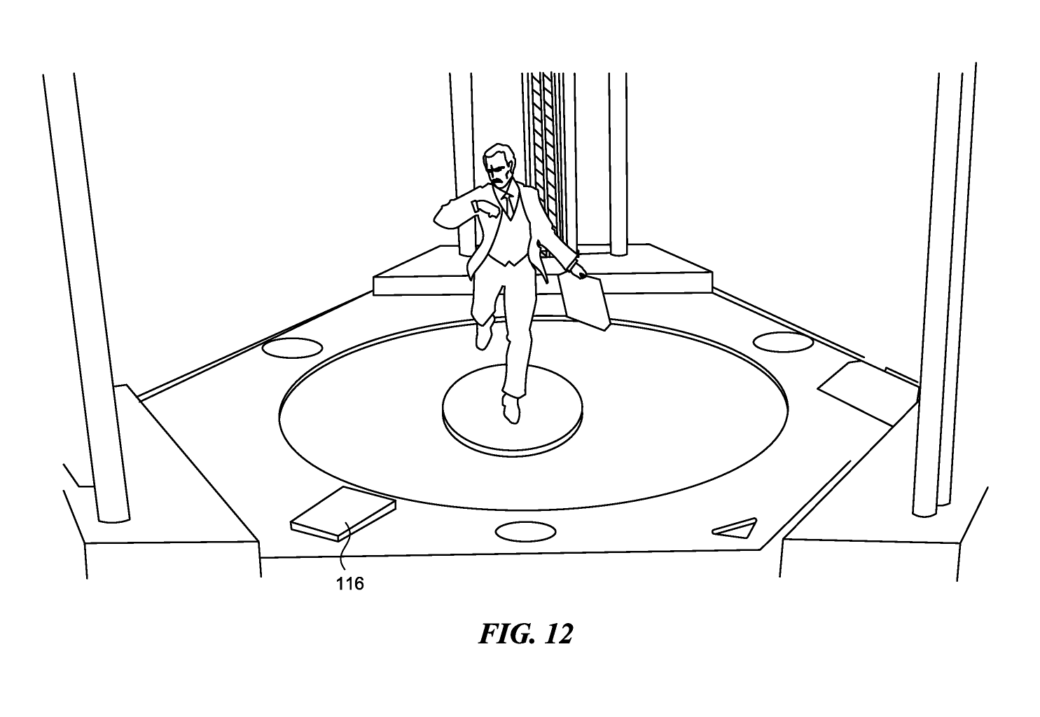

FIG. 10 is a perspective view of the base station 116 with the rotatable platform 110 exposed, in accordance with various embodiments. FIG. 11 is a perspective view of the base station 116 with a light projector (e.g., one of the light projectors 118) exposed, in accordance with various embodiments. FIG. 12 is a perspective view of the base station 116 while scanning an object with the light projector, in accordance with various embodiments.

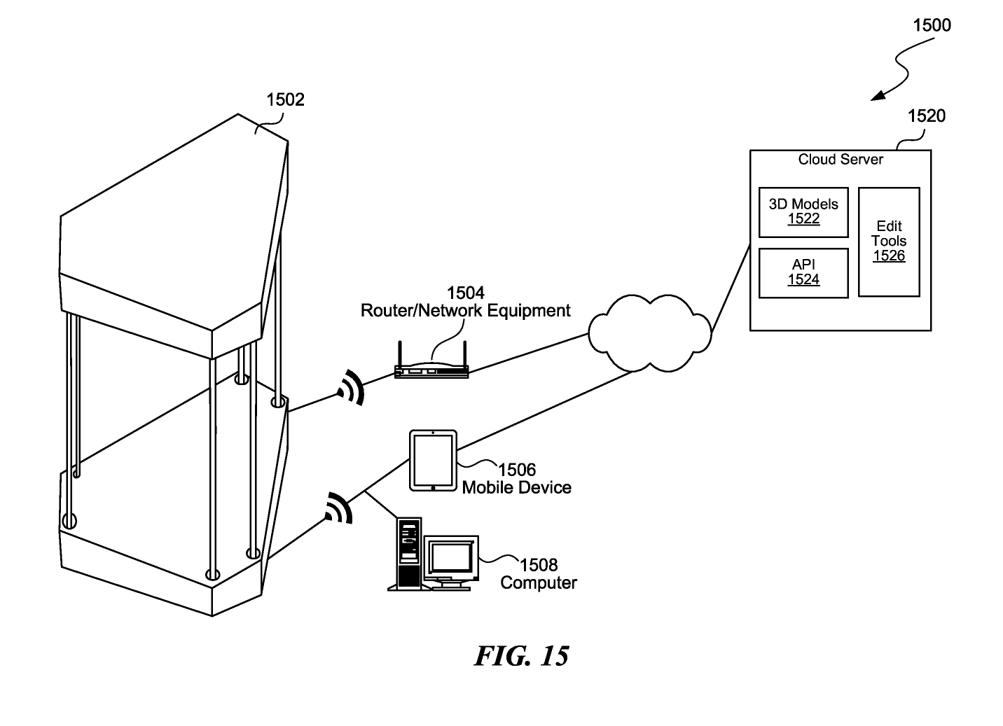

FIG. 15 is a block diagram of a consumer 3D printer system 1500, in accordance with various embodiments. The consumer 3D printer system 1500 can include a 3D printer 1502 (e.g., the 3D printer 100 of FIG. 1). The 3D printer 1502 can be coupled to a network equipment 1504, a mobile device 1506, a computer 1508, or any combination thereof. The 3D printer 1502 can couple to these components through a wired interface (e.g., USB), a wireless interface (e.g., Bluetooth, WiFi, WiFi Direct, or NFC), or a combination thereof.

In some embodiments, the 3D printer 1502 can connect with a cloud server 1520 through the network equipment 1504. The cloud server 1520 can store 3D models in a 3D model database 1522. The cloud server 1520 can provide an interface through one or more application programming interfaces (APIs) 1524. The APIs 1524 can provide an application interface with the 3D printer 1502 (e.g., to send 3D models or commands to the 3D printer 1502). The APIs 1524 can provide an application interface for a control device (e.g., the mobile device 1506). For example, the API for the control device can provide various functional services, such as model editor tools 1526. The APIs 1524 can provide one or more application interfaces for 3rd party services and programs, such as 3rd party control applications and 3rd party 3D model editing tools.

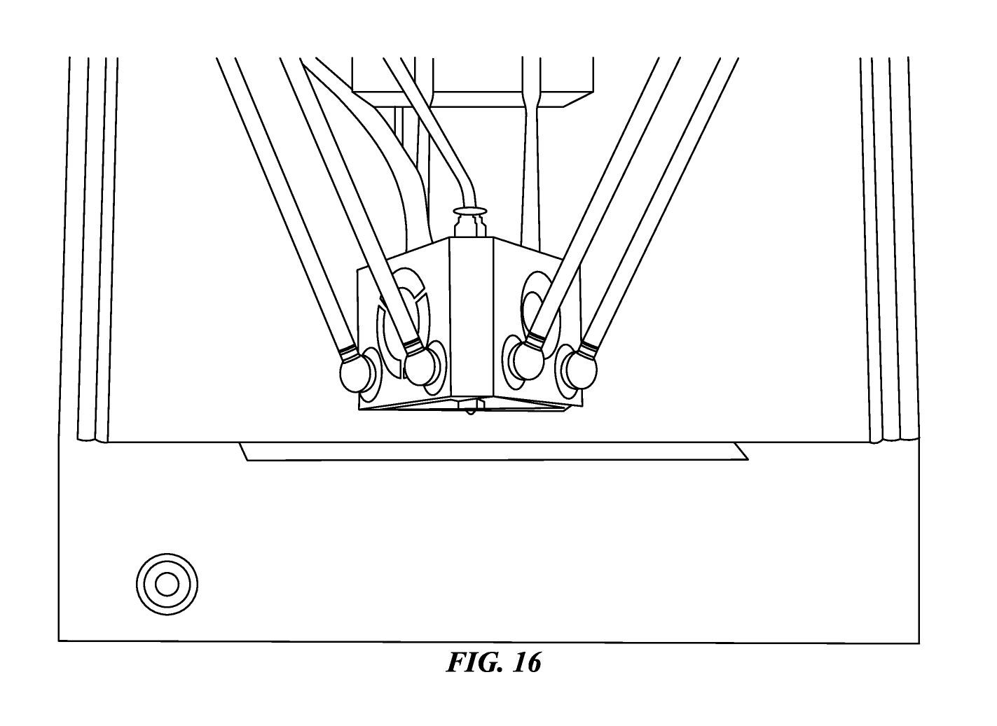

FIG. 16 is a side view of the print head 500 of FIG. 5 over the base station 116 of the 3D printer 100 of FIG. 1. A removable platform 1602, such as the removable platform 402, can be placed over the base station 116.

Portions of logic components (e.g., including hardware components, executable modules, and databases) associated with the disclosed 3D printers or 3D printer systems may be implemented in the form of special-purpose circuitry, in the form of one or more appropriately programmed programmable processors, a single board chip, a field programmable gate array, a network capable computing device, a virtual machine, a cloud-based terminal, or any combination thereof. The logic components may be hardware-based, firmware-based, software-based, or any combination thereof. For example, the logic components described can be implemented as instructions on a tangible storage memory capable of being executed by a processor or other integrated circuit chip. The tangible storage memory may be volatile or non-volatile memory. In some embodiments, the volatile memory may be considered “non-transitory” in the sense that it is not transitory signal. Memory space and storages described in the figures can be implemented with the tangible storage memory as well, including volatile or non-volatile memory.

Each of the logic components may operate individually and independently of other components. Some or all of the logic components may be executed on the same host device or on separate devices. The separate devices can be coupled through one or more communication channels (e.g., wireless or wired channel) to coordinate their operations.

Some or all of the logic or mechanical components may be combined as one component. A single component may be divided into sub-components. For example, each logic sub-component can perform separate method step or method steps of the single component; and each mechanical sub-component can be modularly coupled to other mechanical sub-components to form the whole.

In some embodiments, at least some of the logic components share access to a memory space. For example, one logic component may access data accessed by or transformed by another logic component. The logic components may be considered “coupled” to one another if they share a physical connection or a virtual connection, directly or indirectly, allowing data accessed or modified from one logic component to be accessed in another logic component. The mechanical components may be considered “coupled” to one another by mechanically interfacing with one another through direct contact or one or more mechanical intermediary.

Some embodiments of the disclosure have other aspects, elements, features, and steps in addition to or in place of what is described above. These potential additions and replacements are described throughout the specification.

What is claimed is:

1. A tooling machine assembly comprising:
a top cap;
a base station;
slider blocks;
rods that are adapted to support the top cap, run through the slider blocks and plug into the base station;
slider arms with rounded ends that are adapted to magnetically attach to the slider blocks and magnetically attach to a tool head; and
a controller configured to control movement of the slider blocks along the rods via one or more motors or actuators.

2. The tooling machine assembly of claim 1, wherein the top cap includes a filament extruding motor controlled by the controller.

3. The tooling machine assembly of claim 2, wherein the top cap includes multiple extruding motors to support printing two types of material at once.

4. The tooling machine assembly of claim 1, wherein the top cap includes a plastic furnace to accept recyclable plastic as filament.

5. The tooling machine assembly of claim 1, further comprising a removable glass platform adapted to fit on top of the base station.

6. The tooling machine assembly of claim 1, wherein the base station includes:
a rotatable platform controlled by the controller;
a light projector capable of illuminating a linear light pattern;
an optical scanner configured to capture the linear light pattern reflected from an object on the rotatable platform while the rotatable platform is being rotated.

7. The tooling machine assembly of claim 6, wherein the light projector is adapted to hide beneath a top surface of the base station at a first mechanical configuration and to be exposed over the top surface at a second mechanical configuration; and wherein the first mechanical configuration is capable of changing to the second mechanical configuration via a click release mechanism.

8. The tooling machine assembly of claim 1, wherein the base station includes a modular tool slot adapted to fit at least a rotatable platform, a heating plate, a machine-readable memory device, a logic computing module, or any combination thereof.

9. The tooling machine assembly of claim 1, wherein the heating plate is adapted to heat a removable glass plate that is adapted to fit over the base station.

10. The tooling machine assembly of claim 1, wherein the tool head is a 3D filament print head, a laser tool, a milling tool, a pen holder, or any combination thereof.

11. The tooling machine assembly of claim 1, wherein the tool head is a print head, and the print head further comprises:
an air intake fan, an air exhaust fan, and a filament cooling fan that is directed at a nozzle of the print head.

12. The tooling machine assembly of claim 1, wherein the base station includes multiple force sensors thereon; and wherein the controller is configured to read the force sensors to calibrate an operation of the tool head on a platform that is laid on top of the base station.

13. The tooling machine assembly of claim 12, wherein the force sensors are overlaid with a ferromagnetic material such that a removal platform with corresponding ferromagnetic material is able to magnetically attach to the force sensors to create a mechanical coupling.

14. A method of operating a 3D tooling machine to scan a target object, comprising:
projecting a linear light pattern from a light projector on a base station of the 3D tooling machine capable of 3D printing;
capturing images via a camera directed at a space above an object platform on the base station while rotating the object platform, wherein the camera is attached to a camera arm extended from the base station;
filtering the images based on a specific spectral characteristic of the light projector;
analyzing attenuation of the linear light pattern reflected from a target object on the object platform; and
constructing a 3D surface model based on the attenuation at different heights.

15. The method of claim 14, further comprising:
saving the 3D surface model in a memory; and
accessing the 3D surface model to replicate the target object using a thermoplastic filament print head.

16. The method of claim 14, wherein projecting the linear light pattern is in response to detecting that the light projector is exposed through a click-release mechanism from the base station.

17. The method of claim 14, wherein capturing the images is in response to detecting that the camera arm is released through a click-release mechanism from the base station.

18. A method of operating a 3D tooling machine comprising:
accessing a binary file indicating consecutive 3D coordinates and an indication of an operation mode;
calibrating a 3D movement space of a tool head by moving the tool head vertically downwards until a force sensor, under a platform, detects that the tool head has made contact with an object on the platform or with the platform; and
moving the tool head in the 3D movement space according to the binary file.

19. The method of claim 18, wherein accessing the binary file includes receiving the binary file via a wireless interface of the 3D tooling machine.

20. The method of claim 18, wherein accessing the binary file includes accessing the binary file from an internal memory, a portable memory, or an external memory.
